(19) United States
(12) Patent Application Publication
(10) Pub. No.: US 2011/0286297 A1
(43) Pub. Date: Nov. 24, 2011

(54) INFUSER FOR SUPERSATURATING A LIQUID WITH A GAS

(76) Inventor: Robert Scott Decker, Carthage, MO (US)

(21) Appl. No.: 12/785,043

(22) Filed: May 21, 2010

(51) Int. Cl. B01F 13/02; C02F 1/00

(52) U.S. Cl. 366/101; 261/112.1

(57) ABSTRACT

A gas infuser facilitates dissolving a gas into a liquid to produce a supersaturated liquid. A liquid in the infuser is spread over the surfaces of infuser structures in the infuser chamber such that the liquid forms a film on the surfaces in the presence of a pressurized gas. Preferably the liquid flows by gravity over the surfaces of the infuser structures as it flows in a cascade from an input at the top of the infuser. The infuser described herein may be used with a variety of infuser structures to provide increased surface area for the cascading flow of liquid. The liquid leaves the infuser supersaturated with the gas. The supersaturated liquid can then be used in any one of a variety of industrial type processes. The infuser is preferably a continuous flow process but may also be operated as a batch process. The gas and liquid are preferably introduced together into the infuser under pressure in a non-dissolved state or semi-dissolved state.

### BACKGROUND

1. Technical Field

This disclosure generally relates to dissolving a gas into a liquid, and more specifically relates to a gas infuser that utilizes a cascading flow of liquid over infuser structures in the presence of a pressurized gas for supersaturating the liquid with the gas.

2. Background Art

There are many applications where it is desirable to dissolve a gas into a liquid. Some applications where it is desirable to dissolve a gas into a liquid include aerobic wastewater treatment systems, sewer lift stations, aerated lagoons, ozonation of water or other liquids, coal liquification, etc. The maximum concentration of gas achievable in a liquid ordinarily is governed by Henry's Law. At ambient pressure, the relatively low solubility of many gases, such as oxygen or nitrogen, within a liquid such as water produce a low concentration of the gas in the liquid. However, in applications such as the above, it is often advantageous to employ a gas concentration within the liquid which greatly exceeds its solubility at ambient pressure.

### BRIEF SUMMARY

The disclosure and claims herein are directed to a gas infuser that facilitates dissolving a gas into a liquid to produce a supersaturated liquid. The liquid in the infuser is spread over the surfaces of infuser structures in the infuser chamber such that the liquid forms a film on the surfaces in the presence of a pressurized gas. Preferably the liquid flows by gravity over the surfaces of the infuser structures as it flows in a cascade from an input at the top of the infuser. The infuser described herein may be used with a variety of infuser structures to provide increased surface area for the cascading flow of liquid. The liquid leaves the infuser supersaturated with the gas. The supersaturated liquid can then be used in any one of a variety of industrial type processes. The infuser is preferably used in a continuous flow process but may also be operated as a batch process. The gas and liquid are preferably introduced together into the infuser under pressure in a non-dissolved state or semi-dissolved state.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 illustrates an example of the basic structure of a gas infuser as described and claimed herein;

FIG. 2 illustrates an example of a gas infuser with packing material for the infuser structures as described and claimed herein;

FIG. 3 illustrates two examples of an infuser packing material as described and claimed herein

FIG. 4 illustrates an example of a gas infuser with inclined plates for the infuser structures as described and claimed herein;

FIG. 5 illustrates another example of a gas infuser with multiple mixing plates as the infuser structures as described and claimed herein;

FIG. 6 is a method flow diagram for a gas infuser as claimed herein; and

FIG. 7 is another method flow diagram for a gas infuser with a mix controller as claimed herein.

### DETAILED DESCRIPTION

Described herein is a gas infuser that facilitates dissolving or infusing a gas into a liquid to produce a supersaturated liquid. The liquid in the infuser is spread over the surfaces of infuser structures in the infuser chamber such that the liquid forms a film on the surfaces in the presence of a pressurized gas. Preferably the liquid flows by gravity over the surfaces of the infuser structures as it flows in a cascade from an input at the top of the infuser. The infuser described herein may be used with a variety of infuser structures to provide increased surface area for the cascading flow of liquid. As used herein, a cascading flow of liquid is a flow of liquid by gravity over multiple structures. The liquid leaves the infuser supersaturated with the gas. The supersaturated liquid can then be used in any one of a variety of industrial type processes. The infuser is preferably a continuous flow process but may also be operated as a batch process. The gas and liquid are preferably introduced together into the infuser under pressure in a non-dissolved state or semi-dissolved state.

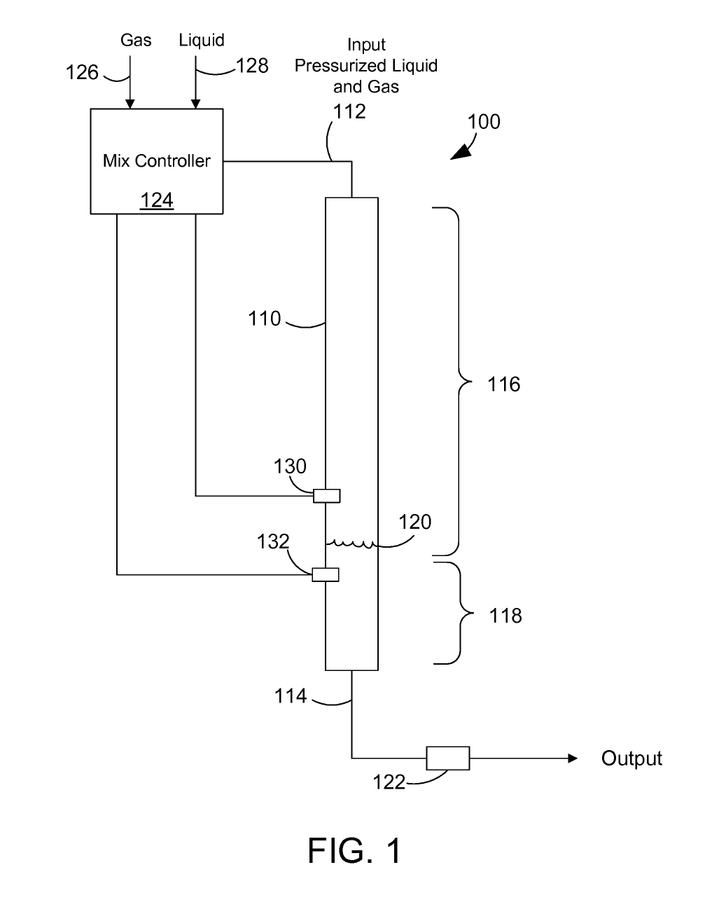

FIG. 1 illustrates an example of a basic structure for an infuser 100 as described and claimed herein. The infuser 100 includes a pressurizable infuser chamber 110 with an input 112 at the top and an output 114 at the bottom. The input 112 supplies a pressurized mixture of a liquid with an undissolved or semi-dissolved gas into the infuser chamber 110 with the remainder of the gas supplied as bubbles in the liquid. As the gas and liquid enter through the input 112 and fill the infuser chamber, an upper portion of the chamber 110 fills with the gas to create a gas region 116 of the chamber, and a lower portion 118 of the infuser chamber 110 fills with the liquid as shown by the liquid level 120. The output 114 from the infuser chamber 110 is at or near the bottom of the chamber and is connected to a valve 122 which preferably is a reducing valve to reduce the pressure of the liquid at the output for use. The pressurized liquid exiting from the valve 122 is a liquid supersaturated with gas. As described below, the infuser chamber 110 includes infuser structures (illustrated in subsequent Figures and described below) to provide multiple cascading surfaces for the liquid. These infuser structures are primarily in the upper portion or gas region 116 of the infuser 110 but may extend into the bottom portion 118 in the liquid. The infuser structures preferably increase the surface area for a liquid film in the gas region of the chamber by about 35% compared to the same chamber without infuser structures, and most preferably increase the surface area by about 70% or more.

Again referring to FIG. 1, the infuser 100 may also include a mix controller 124 to mix a gas 126 and a liquid 128 and supply the pressurized liquid and gas to the chamber as discussed above. The infuser 100 preferably includes a liquid port 130 and a gas port 132 connected to the mix controller 124 for maintaining the liquid level 120 in a given range in the infuser chamber 110. These ports are particularly useful when using the infuser in a continuous process mode. In a first example for the infuser shown in FIG. 1, the liquid port 130 and the gas port 132 include a sensor to determine when additional gas needs to be added to the chamber. When the liquid level 120 rises to the level of the liquid port 130, the sensor at the port senses the level of the liquid. The liquid port sensor then sends a signal to the mix controller 124 to increase the gas entering the infuser chamber 110. Similar to the liquid port 130, a gas port 132 is also used to sense and adjust the gas level to maintain the liquid level. When the liquid level 120 drops to or below the gas port 132, a sensor at the gas port sends a signal to the mix controller 124 to decrease the gas flow and bring the level of the liquid 120 back up to the desired range. In this first example, the liquid flow through the infuser was assumed to be essentially constant. Alternatively, the liquid flow could be adjusted instead of the gas flow or in combination with the gas flow to maintain the liquid level in the desired range. The liquid level is preferably maintained in the range between ports 130 and 132 such that the output of the gas infuser 100 will be a substantially bubble free liquid except for dissolved gas and the micro bubbles described below.

In another example of an infuser as illustrated in FIG. 1, the mix controller 124 uses the liquid port 130 and the gas port 132 to maintain the liquid level by porting a portion of the liquid and/or gas from the infuser. The liquid port 130 could be used to bleed off a portion of the liquid to limit the liquid level if the liquid level rises beyond the liquid port 130. Similarly, the gas port 132 can be used by the mix controller to vent undissolved gas if the liquid level falls to the level of the gas port 132. The vented gas ported from the gas port 132 may be recycled back into the process and used in the incoming liquid/gas mixture at the input 112.

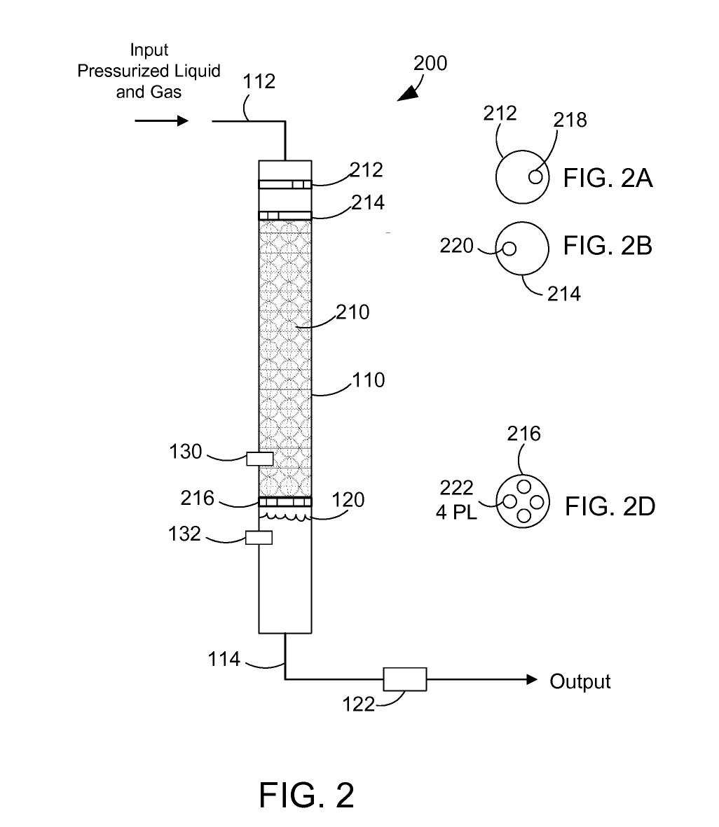

FIG. 2 illustrates another example of a gas infuser 200 as claimed herein. The gas infuser 200 is similar to gas infuser 100, where like item numbers are the same structures as those described above with reference to FIG. 1. As introduced above, the infuser chamber 110 includes infuser structures to provide increased surface area for the liquid. As used herein, the general term infuser structure refers to these different structures to provide surfaces for the liquid to spread out on and form a film that is exposed to the pressurized gas. In the example shown in FIG. 2, the infuser structures include a first mixing plate 212, a second mixing plate 214, a bottom mixing plate that also serves as a packing retainer 216 and packing material 210. The space between the second mixing plate 214 and packing retainer 216 is filled with the packing material 210. The surface area of the infuser structures, in this case the packing material 210, provides increased surface area to effectuate the gas to liquid transfer and thereby produce a supersaturated liquid as described herein. The packing material 210 is discussed further below.

FIG. 2A shows a top view of the first mixing plate 212. The first mixing plate 212 in this example is a metal plate placed inside the infuser chamber 110 with at least one hole 218 to allow the liquid and gas to cascade through the infuser chamber 110. The second mixing plate 214 is placed a short distance below the first mixing plate 212. The second mixing plate 214 also has at least one hole 220. The hole 220 in the second mixing plate is placed offset to the hole 218 in the first mixing plate to increase the mixing of the liquid with the undissolved gas as it enters from the top of the chamber 210 and cascades over the mixing plates and through the holes 218, 220. The bottom mixing plate and packing retainer 216 is placed near the bottom of the infuser chamber 110. Similar to the first mixing plate 212 and second mixing plate 214, the packing retainer 216 includes one or more holes 222 for allowing the saturated liquid to pass through the packing retainer 216 to the bottom of the infuser chamber 110. The holes 222 in the packing retainer 216 are sized to prevent the packing material 210 from passing through them such that the packing material is retained above the packing retainer 216.

As introduced above with reference to FIG. 1, a gas infuser as described herein uses infuser structures in the infuser chamber 110 to provide increased surface area for cascading the flow of the liquid through the infuser chamber 110. In the example shown in FIG. 2, the gas infuser 200 uses a packing material 210 for the infuser structures. The packing material 210 fills the space in the infuser chamber 110 between the bottom mixing plate 214 and the packing retainer 216. The packing material can comprise one of many commercially available packing materials. These packing materials are sometimes referred to as “random tower packing”, “column packing” or “fill material”. These packing materials are commonly used for mass transfer, heat transfer, particulate collection and scrubbers. The packing material 210 may be made of a variety of materials. Some of the more common are plastic, polypropylene, polyvinylchloride (PVC), polyvinylidene fluoride (PVDF), stainless steel, etc. A suitable material for the packing is chosen to withstand the environmental conditions of the infuser including the type of gas and liquid in the infuser. The purpose of the packing material 210 is to provide increased surface area for the gas to infuse into the liquid. The packing material provides increased surface area inside the infuser chamber for a film of the liquid in the presence of the pressurized gas. The liquid spreads over the many surfaces of the packing material 210 as it cascades down through the levels of the packing material 210 in the infuser chamber 110. The infuser structures, in this case the packing 210, thus create a cascade flow of the liquid with increased surface area for the film interface where the pressurized gas dissolves or infuses into the liquid to produce a supersaturated liquid. The packing material preferably increases the surface area for the film interface of the liquid by about 100 percent or more compared to an infuser chamber without infuser structures.

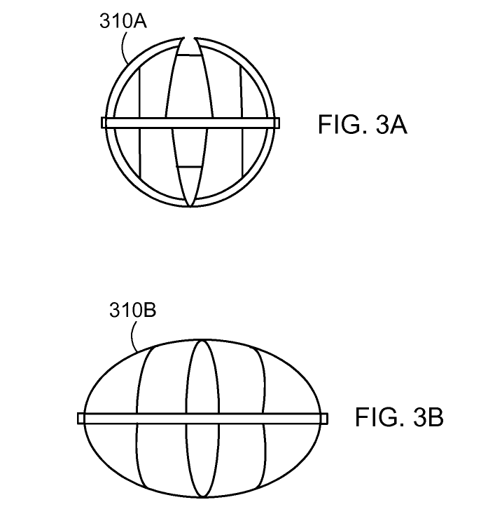

The shape and structure of common, commercially available packing materials are shown in FIG. 3. The packing material 210 in FIG. 2 would comprise many of these structures. FIG. 3A illustrates a spherical shaped packing material 310A. The packing material 310A is open in the interior except for the lines shown to allow the liquid and gas to flow through the packing material. In this example, the packing material 310A is about 1.5 inches (3.8 cm) in diameter. FIG. 3B shows a similar packing material 310B in a torroidal shape. Many other shapes and sizes are known in the art. The disclosure and claims herein expressly extend to any suitable shape and size of packing material, whether currently known or developed in the future.

A specific example of the gas infuser shown in FIG. 2 will now be described. The objective of this example is to achieve a high dissolved oxygen (DO) level in a relatively clear water for injection into a waste-water treatment application or the like. A clear water running about 60 gallons per minute (227 liters per minute) is combined with about 400 cubic feet per minute (11,328 liters per minute) of oxygen and introduced together into input 112 of the gas infuser 200. The gas infuser 200 in this example has an infuser chamber 110 that is made of a cylindrical metal pipe that is eight inches in diameter and about five feet long. The mixing plates 212, 214 are secured inside the infuser chamber 110. As an example, the mixing plates may be secured in the infuser chamber 110 with spacer rods (not shown) between the first and second mixing plates, between the second mixing plate 214 and the packing retainer, and between the packing retainer and the bottom of the infuser chamber. The holes in the mixing plates are made to be about one inch such that the packing material 210, which has a diameter of approximately 1.5 inches, will not pass through the holes. The packing material used in this example is that illustrated in FIG. 3A and made with PVC or PVDF. This packing material increases the surface area for the liquid about 500% compared to the chamber without the packing material, where this particular packing material provides about 30 square feet of surface area for each cubic foot of volume. Other packing materials could be used that may increase the surface area more or less than 500%.

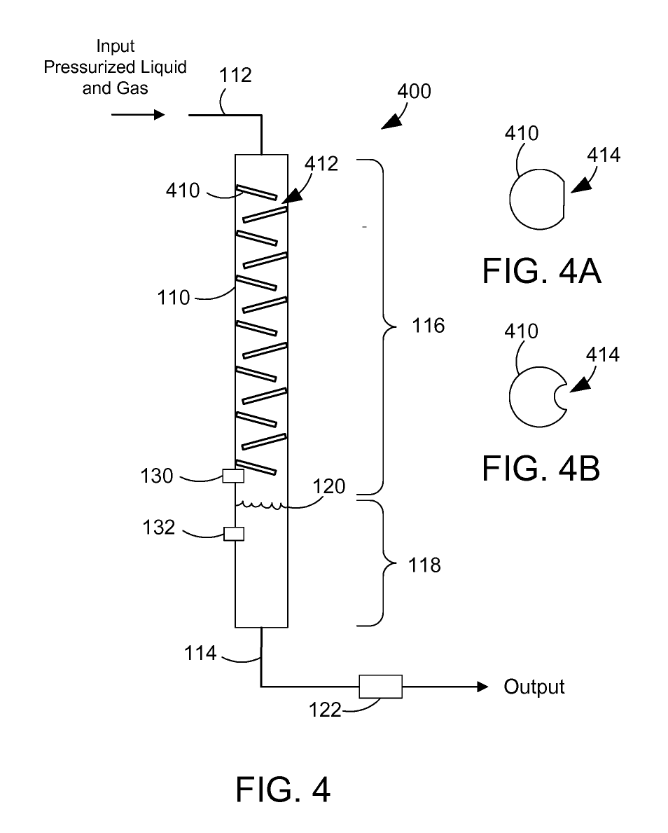

FIG. 4 illustrates another example of a gas infuser 400 as claimed herein. The gas infuser 400 is similar to gas infuser 100, where like item numbers are the same structures as those described above with reference to FIG. 1. As discussed above, the infuser chamber 110 includes structures to provide increased surface area for a film of the liquid to be exposed to the pressurized gas. In the example shown in FIG. 4, the infuser structures include a number of inclined plates 410 arranged in a cascade in the infuser. In this example, the inclined plates 410 are disposed on opposite sides of the infuser chamber 110 and are placed at an incline such that the liquid will flow in a cascading manner down the first incline plate to subsequent plates. The space 412 between the inclined plates allows any particulate matter in the liquid to pass through the infuser chamber 110 without clogging the chamber. FIG. 4A and FIG. 4B show two examples for the shape of the inclined plates 410 as seen from a top view. For an infuser chamber that is a cylindrical pipe, the inclined plates are preferably a circular shape with a cutout 414 to allow the liquid to pass to the next level. The inclined plates 410 are preferably slightly smaller in diameter than the infuser chamber 110 such that liquid also flows between the inclined plates and the inner wall of the infuser chamber. This insures that the surface area of the infuser chamber is also utilized to infuse the gas into the liquid. The inclined plates 410 can be mounted inside the infuser chamber 110 in any suitable manner.

Again referring to the example in FIG. 4, the number of the inclined plates 410 and the spacing 412 are chosen based on the application. The example shown in FIG. 4 does sacrifice infuser structure surface area compared to the previous example, but it in some applications such as waste water treatment, the increased solubility of the gas in the liquid makes up for the decreased surface area. The surface area of the infuser structures, in this case the inclined plates 410, provides increased surface area to effectuate the gas liquid transfer and thereby produce a supersaturated liquid as described herein. In other respects, the gas infuser shown in this example operates in a similar manner as discussed above. In the illustrated example, there are 13 inclined plates 410 equally spaced in about the top seven feet of an eight foot cylindrical pipe that makes up the infuser chamber 110. In this example, the inclined plates have a surface area of about 47 square inches each. In this example the surface area of the bottom side of the infuser structures is ignored since the flow of liquid may be gentle enough that there is no flow over the bottom surfaces of the inclined plates. The gas filled portion 116 of the infuser chamber 110 has a surface area of about 1700 square inches. The infuser structures in this example increase the surface area for the water film in the chamber by about 35% compared to the same chamber without infuser structures.

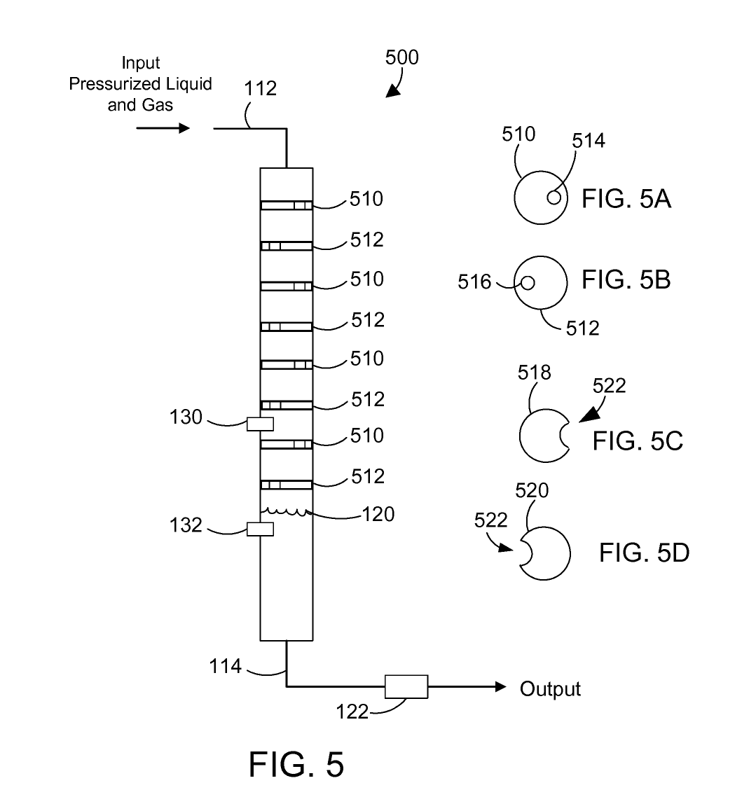

FIG. 5 illustrates another example of a gas infuser 500 as claimed herein. The gas infuser 500 is also similar to gas infuser 100 described with reference to FIG. 1. In the example shown in FIG. 5, the infuser structures include a number of mixing plates 510, 512. The mixing plates 510, 512 are similar to the mixing plates 512, 514 described above with reference to FIG. 2. The mixing plates 510, 512 are secured in the infuser chamber sequentially in a vertical series. The mixing plates form a series of cascading mixing chambers. The liquid flows by gravity through the mixing chambers and forms a film of the liquid over the plates to increase the surface area of the liquid exposed to the gas. The agitation of the liquid may also ensure the liquid is washed over the bottom surfaces of the mixing plates such that the bottom surfaces of the mixing plates also contribute to the increased surface area of the infuser structures. In addition, the liquid splashes about as it moves through the cascading mixing chambers. The splashing liquid increases the surface area of the liquid exposed to the pressurized gas by creating droplets of liquid that are splashed through the gas and increasing the surface area by splashing the liquid about. The series of mixing chambers may thus provide an additional increase in the surface area of the liquid exposed to the gas in addition to the increased surface area due to the liquid on the surface of the infuser structures due to the droplets generated by the splashing liquid.

FIG. 5A shows a top view of the first mixing plate 510. The first mixing plate 510 has a single hole 514 on one side of the mixing plate 510. FIG. 5B shows a top view of the second mixing plate 512. The second mixing plate 512 has a single hole 516 on one side of the mixing plate 510. The holes 514, 516 of the alternating mixing plates 510 and 512 are placed such that the liquid cascading through the multiple mixing plates is forced to splash and run over the surfaces of the mixing plates. The surface area of the infuser structures, in this case the mixing plates 510, 512, provides increased surface area to effectuate the gas to liquid transfer and thereby produce a supersaturated liquid as described herein. In other respects, the gas infuser shown in this example operates in a similar manner as discussed above. Any suitable number of mixing plates could be used. FIGS. 5C shows an alternate configuration for a mixing plate 518 that can be substituted for the first mixing plate 510. In this example, the mixing plate 518 has an opening 522 cut into one side of the mixing plate. Similarly, FIG. 5D shows an alternate configuration for a mixing plate 520 that can be substituted for the second mixing plate 512. Similarly, other configurations of mixing plates could include other shapes and various sizes for the holes or openings.

Additional details of the operation of the gas infuser will now be discussed. As noted above, the liquid and the gas are preferably introduced into the pressurizable chamber together as a mixture of liquid and gas where the gas may be partially dissolved in the liquid. Alternatively, the gas and liquid could be supplied to the infuser chamber separately. The chamber may be pressurized continuously by the incoming gas/liquid mixture, or in a batch process by the incoming gas or liquid. Once in the chamber, the liquid runs by gravity in a cascading flow over the infuser structures. The liquid is thus spread into a film on the infuser structures to increase the surface area of the liquid in the presence of the gas to increase the infusion of the gas and thereby supersaturate the gas into the liquid. Preferably, the surface area added by the infuser structures add at least 35% additional surface area for the liquid exposed to the gas compared to a chamber without infuser structures. Most preferably, the infuser structures add surface area more than about 70% compared to a chamber without infuser structures.

The thickness of the liquid on the surfaces of the infuser structures depends on the flow rate of the liquid and the surface area of the infuser structures. The flow rate of the liquid and the needed amount of surface area of the infuser structures are design choices that depend on how much supersaturated liquid is needed and how readily the gas infuses into the liquid. The ability of the gas to infuse into the liquid depends on physical factors such as the type of liquid and gas, and environmental factors such as temperature and pressure of the infuser chamber.

The supersaturated liquid is collected, preferably at the bottom of the chamber and output for external use with substantially no bubbles in the liquid as it exits the chamber. The liquid level is maintained as described above such that essentially all the larger bubbles of gas stay in the chamber and only the supersaturated liquid flows to the output. The supersaturated liquid is output through a pressure reducing valve to match the pressure needed by the target stream of liquid in the application. When the liquid goes through the valve and the pressure is reduced, cavitation occurs to form vapor or micro bubbles in the liquid. The micro bubbles formed in the gas infuser described herein are extremely small and take time to coalesce into larger bubbles. The vapor laden and supersaturated liquid can be introduced into a target stream of liquid for use and the vapor bubbles will dissolve into the target stream before significant bubbles will develop. Thus the target stream may be supplied with an increased amount of dissolved gas.

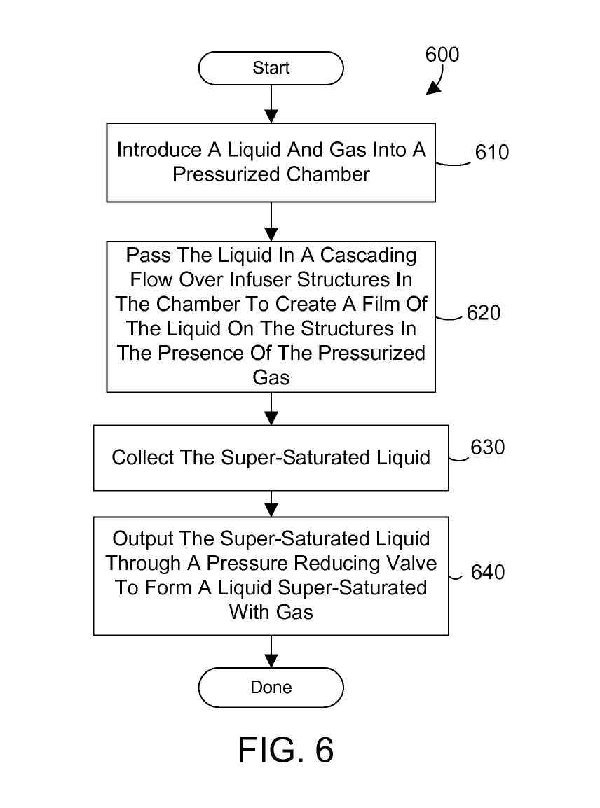

FIG. 6 shows a method 600 for supersaturating a gas into a liquid as disclosed and claimed herein. First, introduce a liquid and a gas into a pressurized chamber (step 610). Then flow the liquid over cascading structures in the chamber to create a film of the liquid on the structures in the presence of the gas to super-saturate the gas into the liquid (step 620). Collect the supersaturated liquid, preferably at the bottom of the chamber (step 630). Then output the supersaturated liquid through a pressure reducing valve to form a liquid that is supersaturated with a gas (step 640). The method is then done.

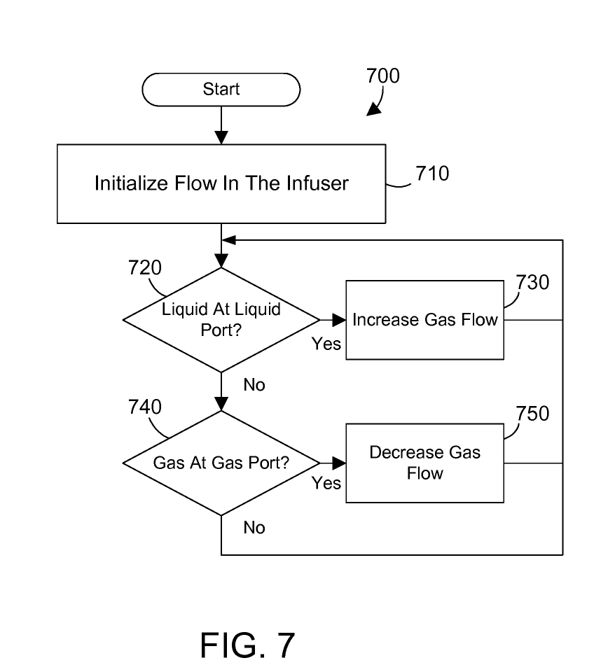

FIG. 7 shows another method 700 for supersaturating a gas into a liquid as claimed herein. First, initialize the flow of the liquid and the gas into a pressurized chamber and establish the liquid level between a liquid port and a gas port (step 710). Then check if the liquid level is at or above the liquid port (step 720). If the liquid level has risen such that it is at or above the liquid port (step 720=yes) then increase the gas flow (step 730) and go back to 720. If the liquid level has not risen such that it is at or above the liquid port (step 720=no), then check if the liquid level is at or below the gas port (step 730). If the liquid level has dropped such that it is at or below the gas port (step 730=yes) then decrease the gas flow (step 750) and go back to 720. If the liquid level has not dropped such that it is at or below the gas port (step 730=no) then go to step 720. The method preferably continues for the duration of the gas infuser operation. The method described above assumes an essentially constant liquid flow. In the alternative, the method may be achieved with a substantially constant gas flow where the liquid flow is decreased in step 730 and increased in step 750.

While specific materials are discussed herein by way of example (such as metal for chamber 100, and mixing plates 212, 214, and inclined plates 410), one skilled in the art will recognize that different materials could be used for different applications. For example, if the liquid or gas presents a caustic environment, various materials that resist such a caustic environment could be used, including plastic and composite materials. The disclosure and claims herein expressly extend to any suitable material, whether currently known or developed in the future. Further, the liquid that is processed in the infuser may be any suitable liquid, and preferably includes clean water, sewage water, pond water, and lake water. While the examples described above refer to oxygen as the gas, other gases could also be used. Other preferred gases include ozone, nitrogen, carbon dioxide, chlorine, and hydrogen sulfide. The disclosure and claims here expressly extend to these gases and other suitable gases.

As described herein, a gas infuser facilitates dissolving or infusing a gas into a liquid to produce a supersaturated liquid. The liquid in the infuser is spread over the surfaces of infuser structures in the infuser chamber such that the liquid forms a film on the surfaces in the presence of a pressurized gas. Preferably the liquid flows by gravity over the surfaces of the infuser structures as it flows in a cascade from an input at the top of the infuser.

One skilled in the art will appreciate that many variations are possible within the scope of the claims. While the examples herein are described in terms of time, these other types of thresholds are expressly intended to be included within the scope of the claims. Thus, while the disclosure is particularly shown and described above, it will be understood by those skilled in the art that these and other changes in form and details may be made therein without departing from the spirit and scope of the claims.

1. An apparatus comprising:
a pressurizable chamber with a gas region in an upper portion;
an input for introducing a liquid and a gas near a top of the chamber and an output near a bottom of the chamber for outputting the liquid supersaturated with the gas; and
a plurality of infuser structures in the gas region of the chamber, wherein the plurality of infuser structures create an increased surface area for the liquid cascading by gravity over surfaces of the plurality of infuser structures to form a film of the liquid in the presence of the gas under a pressure to increase the gas infusion into the liquid.

2. The apparatus of claim 1 wherein the increased surface area created by the plurality of infuser structures is at least 35 percent of a total surface area of the chamber in the gas region.

3. The apparatus of claim 1 wherein the increased surface area created by the plurality of infuser structures is at least 70 percent of a total surface area of the chamber in the gas region.

4. The apparatus of claim 1 wherein the infuser structures comprise column packing material disposed within the gas region of the chamber.

5. The apparatus of claim 4 wherein the increased surface area of the plurality of infuser structures is more than about 100 percent of a total surface area of the chamber in the gas region.

6. The apparatus of claim 1 wherein the infuser structures comprise a plurality of cascading inclined plates to allow the liquid to flow down the plurality of inclined plates and cover the surface of the inclined plates with a film of the liquid.

7. The apparatus of claim 1 wherein the infuser structures comprise a plurality of mixing plates arranged vertically in the chamber that form a plurality of mixing chambers with holes in the plurality of mixing plates that are offset from one mixing plate to the next.

8. The apparatus of claim 1 wherein the liquid is chosen from the following:
clean water, sewage water, pond water, and lake water.

9. The apparatus of claim 1 wherein the gas is chosen from the following:
oxygen, ozone, nitrogen, carbon dioxide, chlorine, and hydrogen sulfide.

10. An apparatus comprising:
a pressurizable cylindrical chamber with a gas region in an upper portion;
an input for introducing a liquid and a gas near a top of the chamber and an output at a bottom of the chamber for outputting the liquid supersaturated with the gas wherein the liquid and the gas are introduced together at the input with the gas partially dissolved in the liquid and the remainder as gas bubbles;
a plurality of infuser structures in the gas region of the chamber, wherein the plurality of infuser structures create an increased surface area for a film of the liquid cascading by gravity over surfaces of the plurality of infuser structures in the presence of the gas under a pressure to increase the gas infusion into the liquid; and
wherein the increased surface area created by the plurality of infuser structures is at least 35 percent of a total surface area of the chamber in the gas region.

11. The apparatus of claim 10 wherein the infuser structures comprise column packing material disposed within the gas region of the chamber.

12. The apparatus of claim 10 wherein the infuser structures comprise a plurality of cascading inclined plates to allow the liquid to flow down the plurality of inclined plates and cover the surface of the inclined plates with a film of the liquid.

13. The apparatus of claim 10 wherein the infuser structures comprise a plurality of mixing plates arranged vertically in the chamber that form a plurality of mixing chambers with holes in the plurality of mixing plates that are offset from one mixing plate to the next, and wherein the liquid flow cascading through the mixing chambers splashes the liquid to create droplets that provide additional surface area of the liquid exposed to the pressurized gas.

14. A method for super-saturating a liquid with a gas, the method comprising the steps of:
(A) introducing a liquid and a gas into a pressurizable chamber;
(B) pressurizing the chamber;
(C) passing the liquid in a cascading flow over infuser structures in the chamber to create a film of the liquid on the infuser structures in the presence of the gas under pressure;
(D) collecting the supersaturated liquid; and
(E) outputting the supersaturated liquid through a valve.

15. The method of claim 14 further comprising the steps of:
(F) initializing the cascading flow of the liquid and a flow of the gas in the pressurizable chamber to establish a level of the liquid between a liquid port and a gas port;
(G) increasing the flow of the gas if the level of the liquid rises to the liquid port; and
(H) decreasing the flow of the gas if the level of the liquid falls to the gas port.

16. The method of claim 14 wherein the valve is a reducing valve and the supersaturated liquid forms micro bubbles of gas.

17. The method of claim 14 wherein steps A and B are combined such that introducing the gas and liquid into the chamber pressurizes the chamber.

18. The method of claim 14 wherein the gas and liquid are introduced into the chamber together as a partially dissolved gas in the liquid.

19. The method of claim 14 wherein the infuser structures comprise column packing material disposed within an upper portion of the chamber in the presence of the gas under pressure.

20. The method of claim 14 wherein the infuser structures comprise a plurality of mixing plates arranged vertically in the chamber that form a plurality of chambers with holes in the plurality of mixing plates that are offset from one mixing plate to the next.
